(19) United States
(12) Patent Application Publication
(10) Pub. No.: US 2026/0077496 A1
(43) Pub. Date: Mar. 19, 2026

(54) CONTROL NODE AND METHOD PERFORMED THEREIN

(71) Applicant: Telefonaktiebolaget LM Ericsson (publ), Stockholm (SE)

(72) Inventors: Sándor RÁCZ, Cegléd (HU); Norbert REIDER, Tényö (HU)

(21) Appl. No.: 19/108,232

(22) PCT Filed: Oct. 5, 2022
(86) PCT No.: PCT/SE2022/050889

§ 371 Date: Mar. 3, 2025

(51) Int. Cl. B25J 9/16

(52) U.S. Cl. CPC B25J 9/1664

(57) ABSTRACT

A method performed by a control node for handling communication with a robot device. The control node determines a time limit for when a maximum tolerable deviation from a trajectory is reached, for at least two control command types. The at least two control command types include a joint-space command and a Cartesian-space command. The control node selects the control command type that reaches the time limit later, based on the determined time limit for the at least two control command types.

### TECHNICAL FIELD

Embodiments herein relate to a control node and a method performed therein. Furthermore, a computer program and a computer readable storage medium are also provided herein. In particular, embodiments herein relate to handling a control command for a robot device.

### BACKGROUND

FIG. 1 illustrates a general architecture of a control node that controls a robot. In general, robotic devices of a robot support different types of control commands. For example, robotic devices such as robotic arms may support velocity commands in joint-space, i.e. rotation velocity of servos in radian per second, and also in Cartesian-space, i.e. velocity in 3D space in m/s. A servo motor, also referred to as servo, is a rotary actuator that allows for precise control of angular position, velocity and acceleration.

Commands in robotics define high-level robot actions or behaviors that utilize the methods defined by the subsystems. A command is a simple state machine that is either initializing, executing, ending, or idle.

Closed-loop communication is the process of acknowledging the receipt of information and clarifying with the sender of the communicated message that the information received is the same as the original, intended information.

Closed-loop control systems use feedback, from e.g. sensors or transducers, to regulate input for the accuracy of output results. Closed-loop control systems are found in many industrial and commercial applications to maintain quality, accuracy, and productivity.

Traditional robotic applications assume wired connection with negligible loss and/or delay and/or jitter within the closed-loop control of servos. Wireless connection usually does not provide as good quality connection as a wired connection. In case of wireless connection being used between a closed-loop control and a robot device, the resistance of the control loop against lost or delayed commands is important.

### SUMMARY

An object of embodiments herein is to provide an improved way of handling control commands to be communicated to a robot device.

According to an aspect of embodiments herein the object may be achieved by a method performed by a control node for handling a control command for a robot device. The control node determines a time limit for when a maximum tolerable deviation from a trajectory is reached, for at least two control command types. The at least two control command types comprise a joint-space command and a Cartesian-space command. The control node then selects the control command type that reaches the time limit later, based on the determined time limit for the at least two control command types.

According to another aspect of embodiments herein, the object is achieved by providing a control node for handling a control command for a robot device. The control node is configured to determine a time limit for when a maximum tolerable deviation from a trajectory is reached, for at least two control command types. The at least two control command types comprise a joint-space command and a Cartesian-space command. The control node is further configured to select the control command type that reaches the time limit later, based on the determined time limit for the at least two control command types.

It is furthermore provided herein a computer program comprising instructions, which, when executed on at least one processor, cause the at least one processor to carry out the method above, as performed by the control node. It is additionally provided herein a computer-readable storage medium, having stored thereon a computer program comprising instructions which, when executed on at least one processor, cause the at least one processor to carry out the method above, as performed by the control node.

Embodiments herein are based on the realisation that by determining a time limit for when a maximum tolerable deviation from a trajectory is reached and selecting the control command type that reaches the time limit later, position error can be decreased when command packet loss and/or delay occurs in the communication between the control node and the robot device. Embodiments herein thus enable improved resistance against control command loss and thereby the communication with a robot device is handled in an efficient manner. A position error may be defined as a distance between a planned and a realized trajectory.

### BRIEF DESCRIPTION OF THE DRAWINGS

Embodiments will now be described in more detail in relation to the enclosed drawings, in which:

FIG. 1 illustrates a general architecture of a control node;

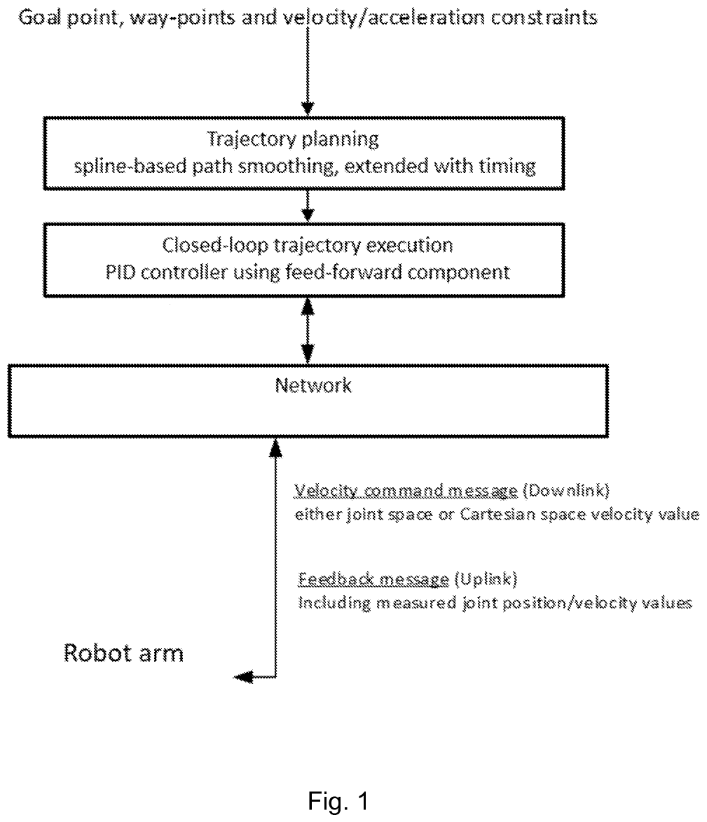

FIG. 2 illustrates a schematic overview of embodiments herein;

FIG. 3 is a flowchart depicting a method performed by a control node according to embodiments herein;

FIG. 4 is a schematic overview illustrating an example of embodiments herein;

FIG. 5 is a flowchart illustrating an example of embodiments herein; and

FIG. 6 is a block diagram depicting a control node according to embodiments herein;

It should be noted that the drawings have not necessarily been drawn to scale and that the dimensions of certain elements may have been exaggerated for the sake of clarity.

### DETAILED DESCRIPTION

Embodiments herein are described in more detail below with reference to the appended figures, in which examples of embodiments are shown. Embodiments herein are not limited to the described examples of embodiments herein; they are rather defined by the appended patent claims. Like numbers in the figures refer throughout to like elements.

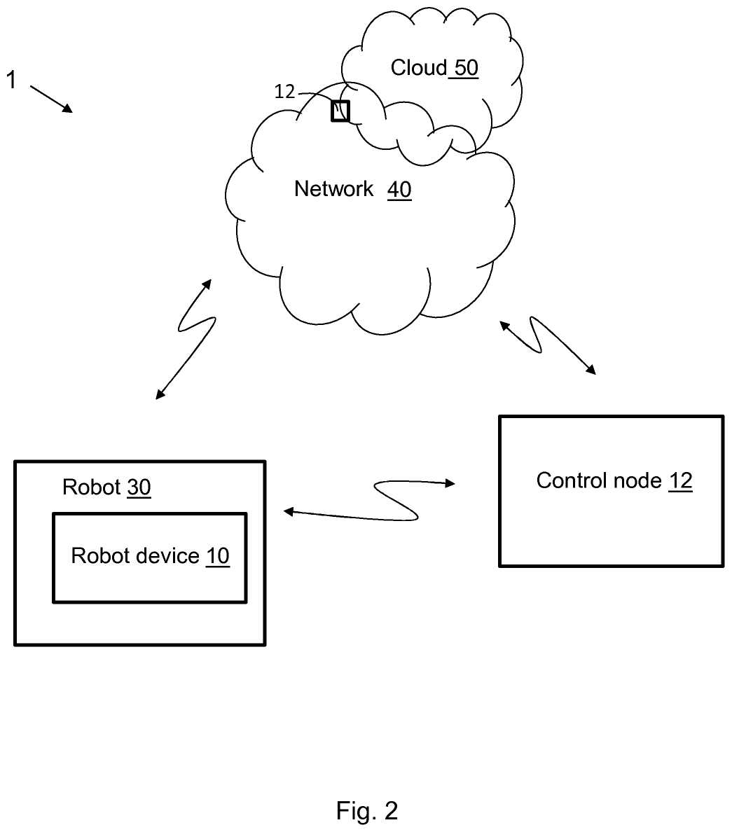

FIG. 2 illustrates a schematic overview of embodiments herein comprising a system 1. The system 1, e.g. a control system, may include one or more different subsystems performing one or more functions or operations. The system 1 comprises one or more control nodes 12 and one or more robots 30. The robot 30 comprises one or more robot devices 10, such as one or more robot arms or links of robot arms. The robot device 10 may also be referred to as robotic devices and the robot arms may also be referred to as robotic arms.

Methods herein may be performed by the control node 12. The control node 12 may be a controller such as a Proportional Integral Derivative (PID) controller. The control node 12 may be placed on the robot 30 and calculations, operations, etc. may then be made locally. The control node 12 may also be located at a remotely located control room. The control node 12 may enable communication with or control of the one or more robots 30, e.g. by wired or wireless data links directly or across one or more communication networks 40. The control node 12 may be located in a cloud 50.

According to embodiments herein the control node 12 determines a time limit for when a maximum tolerable deviation from a trajectory is reached, for at least two control command types. The at least two control command types comprise a joint-space command and a Cartesian-space command. The control node 12 then selects the control command type that reaches the time limit later, based on the determined time limit for the at least two control command types. The selected control command type may then be transmitted to the robot device 30. The joint-space command when used herein may be defined as a control command that contains values per actuator, i.e., per servo motor, that may be velocity, position or torque values that a given actuator may execute. For example, if there are six servo motors in a robot device 10, then a joint-space command contains six values, e.g., velocity command in rad/sec, for each servo motor of the robot device 10. The Cartesian-space command when used herein may be defined as a control command that moves a Tool Centre Point (TCP) of the robot device 10 in 3D. It defines how the end of the robot device 10 should move in the 3D space (X, Y, Z). The values may be the position values where to move e.g. an end of an arm or velocity values (x, y, z) for the desired TCP speed, etc.

Embodiments herein focus on a remote closed-loop control of the robot device 10, e.g. over a wireless connection from e.g. an edge-cloud. An edge cloud architecture may be used to decentralize, e.g. process, power to the edges, e.g. clients and/or devices, of the communication network 40. Embodiments herein enable improved resistance against control command loss and moreover, no additional resources are needed.

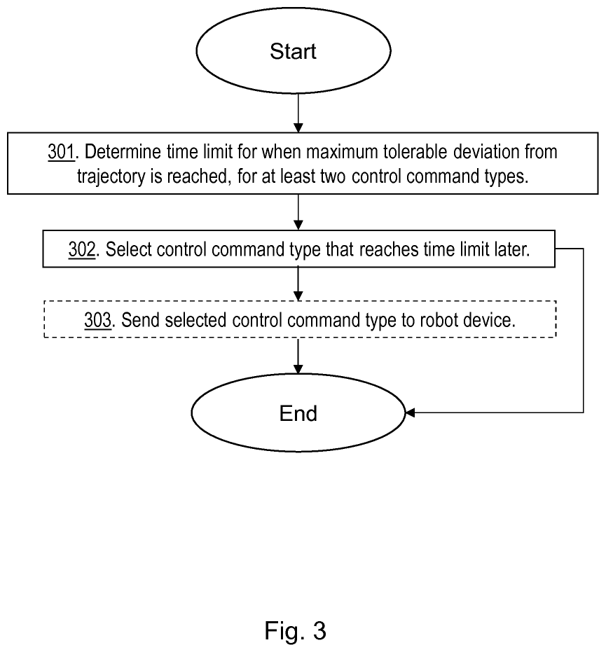

The method actions performed by the control node 12 for handling a control command for the robot device 10, e.g., a robot arm, according to embodiments herein, will now be described with reference to a flowchart depicted in FIG. 3. The actions do not have to be taken in the order stated below, but may be taken in any suitable order. Actions performed in some embodiments are marked with dashed boxes.

Embodiments herein may focus on a feed-forward control of the robot device 12. Commands, such as velocity commands, are sent to the robot device 10 to follow a planned trajectory and the control node 12 may adjust a baseline velocity value based on a position error, i.e., a distance between a planned and a realized trajectory. A realized trajectory may be the trajectory that is actually executed by the robot 30. There may be differences between a trajectory planned by the control node 12, i.e., planned trajectory, and a trajectory actually realized by the robot device 10, i.e., realized trajectory, due to unmodelled or inaccurately modelled factors in the control node 12.

Action 301. To enable the control node 12 to decrease the position error when command packet loss and/or delay occurs in the communication between the control node 12 and the robot device 10, and thereby handle the communication with the robot device 10 in an efficient manner, it is beneficial that the control node 12 selects the most suitable command type out of the command types that are used in the communication between the control node 12 and the robot device 10. Therefore, the control node 12 first determines the time limit for when the maximum tolerable deviation from the trajectory is reached, for at least two control command types. The deviation may be measured in space since a boundary surface around the planned trajectory is considered. The trajectory may be a planned trajectory. The at least two control command types comprise the joint-space command and the Cartesian-space command. Determining the time limit for the joint-space command may comprise calculating how much time that is needed to reach the boundary surface, wherein the calculation is based on a speed of the robot device 10, points of the boundary surface and the trajectory. The boundary surface may be defined as a maximum tolerable deviation from the planned trajectory. Thus, the control node 12 may know the trajectory that would be realized in joint space when there is a gap in the connection and the last control command is continued. The points of the boundary surface may also be known by the control node 12. The speed of the robot device may also be known, so the control node 12 may calculate how much time is needed to reach the boundary surface, i.e., the maximum deviation from the planned trajectory.

And similarly, determining the time limit for the Cartesian-space command comprises calculating how much time that is needed to reach the boundary surface, wherein the calculation is based on the speed of the robot device 10, points of the boundary surface and the trajectory. The speed of the robot device 10, the trajectory and the points of the boundary surface may be known by the control node 12.

The time limit for when the maximum tolerable deviation from the trajectory is reached may be determined when the control commands stop arriving to the robot device 10. This may be due to e.g., a connection loss or similar, so the periodic commands do not arrive to the robot device 10. Furthermore, when the control command in a next control cycle does not arrive to the robot device 10, it may be assumed that the last control command is executed by the robot device 10 until a new control command arrives. Thus, the deviation from the trajectory, e.g. planned trajectory, may occur due to missing commands, and due to the execution of the last arrived command.

Action 302. The control node 12 then selects the control command type that reaches the time limit later, based on the determined time limit for the at least two control command types. This gives more time for performing the communication of the command to the robot device 10. Thereby the most suitable control command type of the at least two command types mentioned above has been selected and position error may be decreased when command packet loss and/or delay or any other problem with the communication occurs.

Action 303. The control node 12 may send the selected control command type to the robot device 10. The robot device 10 may be a link of a robot arm.

Advantages that may be achieved with the embodiments herein are e.g., improved resistance against control command loss, and no additional resource needed for the realization.

Embodiments herein such as mentioned above will now be further described and exemplified. The text below is applicable to and may be combined with any suitable embodiment described above.

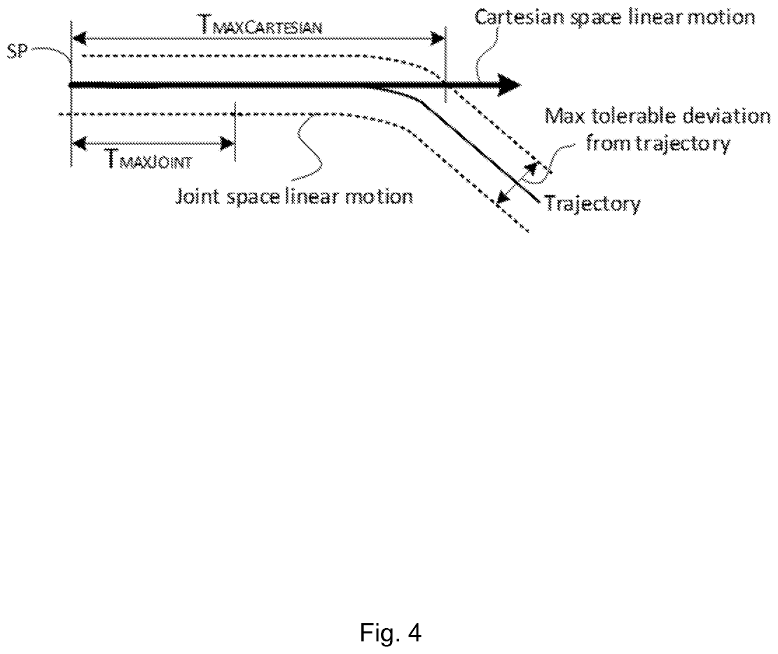

FIG. 4 illustrates an example of embodiments herein. A segment of the trajectory is considered. The robot 30 is at the beginning SP of this segment and the control node 12 needs to decide what type of command to send, e.g., joint-space or Cartesian-space command. The control node 12 therefore calculates the time limit, for the at least two types of control commands, when the max tolerable deviation would be reached assuming that no new control command arrives after this time point. The time limit for the joint-space command is referred to as TMaxJoint in FIG. 4. The time limit for the cartesian-space command is referred to as TMaxCartesian in FIG. 4. The control node 12 selects the command type, e.g. control command type, which achieves the limit later, which in this example as shown in FIG. 4 is the Cartesian-space command. Note that if there is no missing or delayed control commands the at least two control command types result in the same trajectory. The control command type has the best effect when trajectory extrapolation is required due to a missing command. Without receiving any new velocity command the robot remains within the tolerable region until TMaxCartesian or TMaxJoint, depending on the latest received command type.

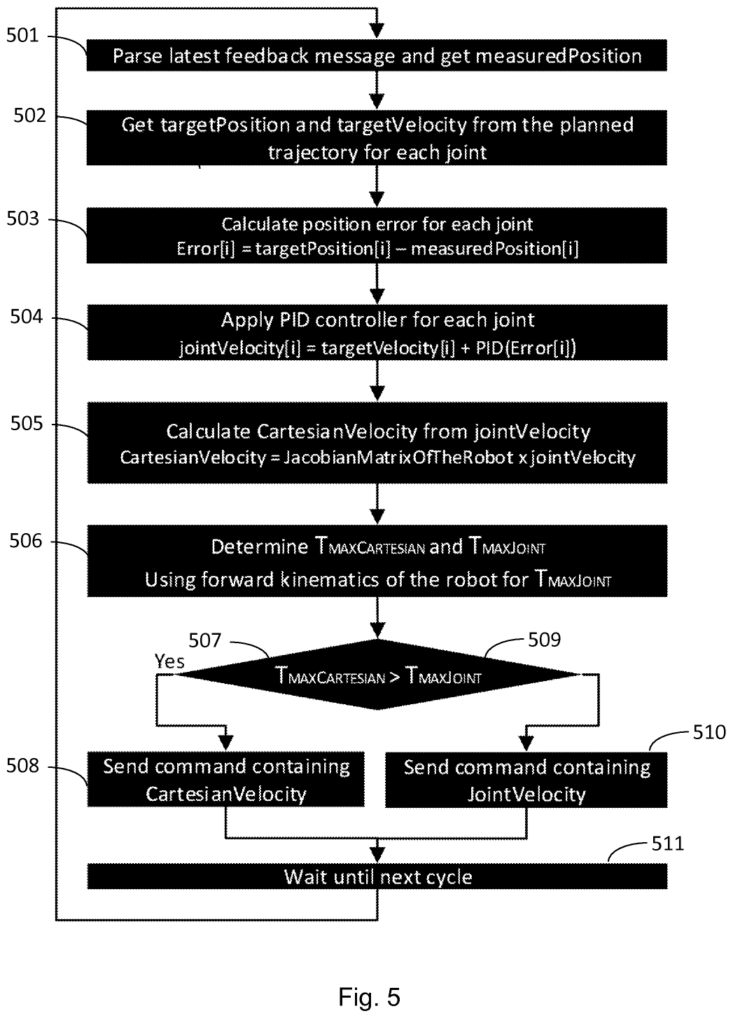

FIG. 5 depicts a flowchart showing actions performed by the control node 12 according to some embodiments herein in which a best command type may be selected in each cycle considering the actual state of the control node 12, e.g. PID controller, as well. The command types in this example are a Cartesian velocity command, e.g. Cartesian velocity and a joint velocity, e.g. joint velocity command.

Action 501. Parse a latest feedback message and get a measured position.

Action 502. Get a target position and a target velocity from a planned trajectory for each joint, e.g., robot device 10.

Action 503. Calculate an error position for each robot device 10, wherein the position error is the target position minus the measured position.

Action 504. Apply PID controller for each joint.

A joint velocity is the target velocity plus the error position for each robot device 10.

Action 505. Calculate a Cartesian velocity from the joint velocity, wherein the Cartesian velocity is a Jacobian matrix of the robot value times the joint velocity.

Action 506. Determine a TMaxCartesian value and a TMaxJoint value using forward kinematics of the robot 30 for the TMaxJoint value. TMaxCartesian may be defined as the time needed to reach the maximum tolerable deviation from the trajectory when Cartesian-space commands are used. TMaxJoint may be defined as the time needed to reach the maximum tolerable deviation from the trajectory when joint-space commands are used.

Action 507. If the TMaxCartesian value is larger than the TMaxJoint value, then send a command containing the Cartesian velocity Action 508.

Action 509. If the TMaxCartesian value is not larger than the TMaxJoint value, then send a command containing the Joint velocity Action 510.

Action 511. Wait until a next cycle.

Omitting the control node 12 state, it may be possible to calculate the command types for the whole trajectory before trajectory execution starts.

If the mixing of different command types is not desirable, then an optimal command type may be selected for the whole trajectory or a group of trajectories.

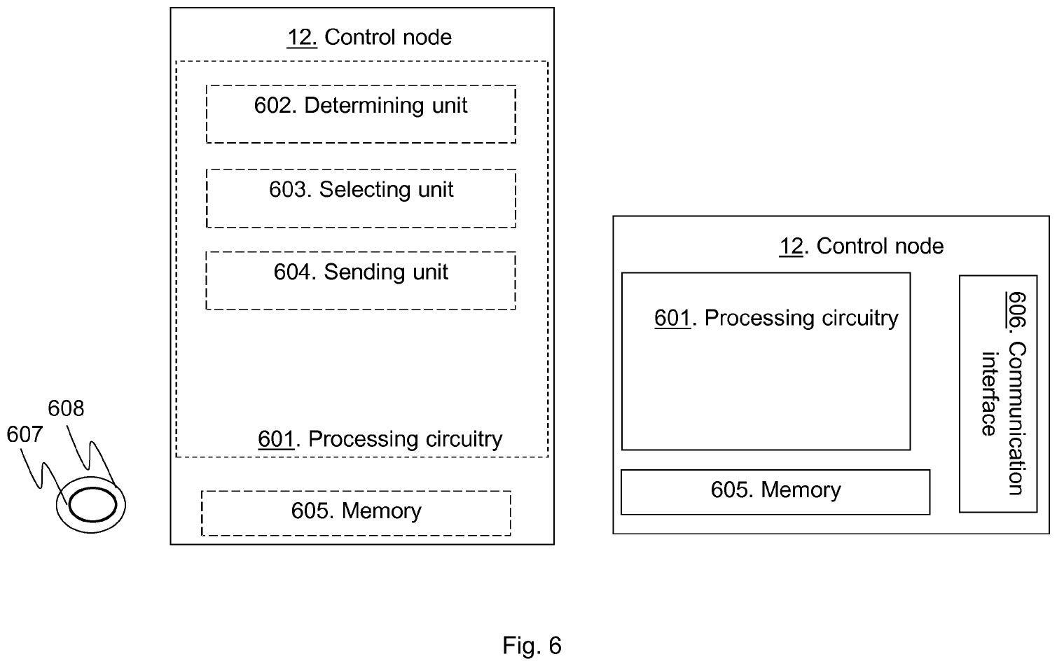

FIG. 6 is a block diagram depicting the control node 12 for handling a control command for the robot device 10, according to embodiments herein.

The control node 12 may comprise processing circuitry 601, e.g. one or more processors, configured to perform the methods herein.

The control node 12 may comprise a determining unit 602. The control node 12, the processing circuitry 601, and/or the determining unit 602 is configured to determine the time limit for when a maximum tolerable deviation from the trajectory is reached, for the at least two control command types, wherein the at least two control command types comprise the joint-space command and the Cartesian-space command. Determining the time limit for the joint-space command may comprise calculating how much time that is needed to reach the boundary surface, wherein the calculation is based on the speed of the robot device 10, points of the boundary surface and the trajectory. Determining the time limit for the Cartesian-space command may comprise calculating how much time that is needed to reach the boundary surface, wherein the calculation is based on the speed of the robot device 10, points of the boundary surface and the trajectory.

The control node 12 may comprise a selecting unit 603. The control node 12, the processing circuitry 601, and/or the selecting unit 603 is configured to select the control command type that reaches the time limit later, based on the determined time limit for the at least two control command types.

The control node 12 may comprise a sending unit 604. The control node 12, the processing circuitry 601, and/or the sending unit 604 may be configured to send the selected control command type to the robot device 10.

The control node 12 further comprises a memory 605. The memory 605 comprises one or more units to be used to store data on, such as control command type information, trajectory information, time-limits, input/output data, metadata, etc. and applications to perform the method disclosed herein when being executed, and similar.

Furthermore, the control node 12 may comprise a communication interface 605 comprising, e.g., a transmitter, a receiver and/or a transceiver.

The method according to the embodiments described herein for the control node 12 is implemented by means of e.g. a computer program product 607 or a computer program, comprising instructions, i.e., software code portions, which, when executed on at least one processor, cause the at least one processor to carry out the actions described herein, as performed by the control node 12. The computer program product 607 may be stored on a computer-readable storage medium 608, e.g. a disc, a universal serial bus (USB) stick or similar. The computer-readable storage medium 608, having stored thereon the computer program product, may comprise the instructions which, when executed on at least one processor, cause the at least one processor to carry out the actions described herein, as performed by the control node 12. In some embodiments, the computer-readable storage medium may be a transitory or a non-transitory computer-readable storage medium.

As will be readily understood by those familiar with communications design, that functions means or circuits may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a control node, for example.

Alternatively, several of the functional elements of the processing units discussed may be provided through the use of dedicated hardware, while others are provided with hardware for executing software, in association with the appropriate software or firmware. Thus, the term “processor”, “control node” or “controller” as used herein does not exclusively refer to hardware capable of executing software and may implicitly include, without limitation, digital signal processor (DSP) hardware and/or program or application data. Other hardware, conventional and/or custom, may also be included. Designers of communications devices will appreciate the cost, performance, and maintenance trade-offs inherent in these design choices.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

When using the word “comprise” or “comprising” it shall be interpreted as non-limiting, i.e. meaning “consist at least of”.

The embodiments herein are not limited to the above described preferred embodiments. Various alternatives, modifications and equivalents may be used.

1. A method performed by a control node for handling a control command for a robot device, the method comprising:
determining a time limit for when a maximum tolerable deviation from a trajectory is reached, for at least two control command types, the at least two control command types comprising a joint-space command and a Cartesian-space command;
selecting the control command type that reaches the time limit later, based on the determined time limit for the at least two control command types; and
sending the selected control command type to the robot device.

2. (canceled)

3. The method according to claim 1, wherein determining the time limit for the joint-space command comprises calculating how much time that is needed to reach a boundary surface, wherein the calculation is based on a speed of the robot device, points of the boundary surface and the trajectory.

4. The method according to claim 1, wherein determining the time limit for the Cartesian-space command comprises calculating how much time that is needed to reach the boundary surface, wherein the calculation is based on the speed of the robot device, points of the boundary surface and the trajectory.

5. The method according to claim 1, wherein the speed of the robot device, the trajectory and the points of the boundary surface are known by the control node.

6. The method according to claim 1, wherein the robot device is a link of a robot arm.

7. The method according to claim 1, wherein the trajectory is a planned trajectory.

8. The method according to claim 1, wherein the time limit for when the maximum tolerable deviation from a trajectory is reached is determined when the control commands stop arriving to the robot device.

9. The method according to claim 1, wherein when the control command in a next control cycle does not arrive to the robot device, it is assumed that the last control command is executed by the robot device until a new control command arrives.

10. The method according to claim 1, wherein the control node is a proportional integral derivative, PID, controller.

11. A control node for handling for handling communication with a robot device, the control node being configured to:
determine a time limit for when a maximum tolerable deviation from a trajectory is reached, for at least two control command types, the at least two control command types comprising a joint-space command and a Cartesian-space command;
select the control command type that reaches the time limit later, based on the determined time limit for the at least two control command types; and
send the selected control command type to the robot device.

12. (canceled)

13. The control node according to claim 11, wherein determining the time limit for the joint-space command comprises calculating how much time that is needed to reach a boundary surface, wherein the calculation is based on a speed of the robot device, points of the boundary surface and the trajectory.

14. The control node according to claim 11, wherein determining the time limit for the Cartesian-space command comprises calculating how much time that is needed to reach the boundary surface, wherein the calculation is based on the speed of the robot device, points of the boundary surface and the trajectory.

15. The control node according to claim 11, wherein the speed of the robot device, the trajectory and the points of the boundary surface are known by the control node.

16. The control node according to claim 11, wherein the robot device is a link of a robot arm.

17. The control node according to claim 11, wherein the trajectory is a planned trajectory.

18. The control node according to claim 11, wherein the time limit for when the maximum tolerable deviation from a trajectory is reached is determined when the control commands stop arriving to the robot device.

19. The control node according to claim 11, wherein when the control command in a next control cycle does not arrive to the robot device, it is assumed that the last control command is executed by the robot device until a new control command arrives.

20. The control node according to claim 11, wherein the control node is a proportional integral derivative, PID, controller.

21. (canceled)

22. A computer-readable storage medium, having stored thereon a computer program product comprising instructions which, when executed on at least one processor, cause the at least one processor to perform a method for handling a control command for a robot device, the method comprising:
determining a time limit for when a maximum tolerable deviation from a trajectory is reached, for at least two control command types, the at least two control command types comprising a joint-space command and a Cartesian-space command;
selecting the control command type that reaches the time limit later, based on the determined time limit for the at least two control command types; and
sending the selected control command type to the robot device.

23. The method according to claim 3, wherein determining the time limit for the Cartesian-space command comprises calculating how much time that is needed to reach the boundary surface, wherein the calculation is based on the speed of the robot device, points of the boundary surface and the trajectory.
